(19) United States
(12) Patent Application Publication
(10) Pub. No.: US 2021/0262571 A1
(43) Pub. Date: Aug. 26, 2021

(54) GASKET

(71) Applicant: NOK CORPORATION, Tokyo (JP)

(72) Inventor: Tasuku ONO, Kumamoto (JP)

(73) Assignee: NOK CORPORATION, Tokyo (JP)

(21) Appl. No.: 16/764,984

(22) PCT Filed: Jul. 29, 2019
(86) PCT No.: PCT/JP2019/029717

§ 371 Date: May 18, 2020

(30) Foreign Application Priority Data
Aug. 31, 2018 (JP) 2018-162622

(51) Int. Cl. F16J 15/10

(52) U.S. Cl. CPC F16J 15/104; B60K 1/04; F16J 15/102

(57) ABSTRACT

A gasket is formed by extrusion and easily fastened into a groove which can be easily formed by presswork. A gasket is configured to seal a gap between a first member that has a sectionally curved groove and a second member. The gasket includes a rubber-like elastic base and at least two pairs of rubber-like elastic fins. The base can be inserted into the groove, and has a height allowing the base to be compressed when the first member and second member are coupled to each other. The fins protrude at different heights from the both side surfaces of the base, and can elastically deform in a direction opposite to an insertion direction when the base is inserted into the groove so that the fins contact the side walls of the groove. The base and the fins are integrally formed with each other as one unitary member by extrusion.

### FIELD

The present disclosure relates to a gasket.

### BACKGROUND

Electric cars begin to enter rapid widespread use with the development of E-Mobility. Electric cars which require a large amount of battery capacity typically include a flat, thin and large battery which is fully accommodated under their floor. Such a battery has a peripheral length which reaches about 3000 to 6000 mm depending on sizes of car bodies. Accordingly, a gasket which seals its battery case has a total length corresponding to the peripheral length.

Japanese Patent Laid-Open Publication No. 2012-122536 (hereinafter, referred to as “Patent Literature 1”) discloses a gasket which seals a case of a battery used for electric, fuel-cell and hybrid cars, and the like. In order to seal a gap between two opposed surfaces (2 and 3) of the battery case, the gasket is fastened to one surface (3) by bolts. A pair of lip-shaped protrusions (12) extend parallel to each other on one surface of the gasket, and a pair of smaller protrusions (13) extend parallel to each other on another surface. The smaller protrusions (13) are brought in tight contact with one surface (3) of the battery case, and the lip-shaped protrusions (12) are brought in tight contact with another surface (2). After that, the gasket can seal a gap between the two surfaces (2 and 3).

### BRIEF SUMMARY

### Technical Problem

Because the gasket disclosed in Patent Literature 1 is fastened to the battery case by using bolts, such a structure requires a number of fastening operation elements. That is, workability is poor. Also, collars (metal rings (4) in Patent Literature 1) which hold a bolt are required, and attachment operation of the collars to the gasket is troublesome. In a case in which the gasket is integrally formed with the collars, such attachment operation can be omitted. In this case, the gasket will be integrally molded with the collars by a die. However, electric car batteries have a peripheral length which reaches about 3000 to 6000 mm. If a die is used for the molding, large manufacturing facilities will be necessarily provided.

Therefore, it is an object of the present disclosure to provide a gasket capable of being formed by extrusion and easily attached into a groove which can be easily formed by presswork.

### Solution to Problem

A gasket according to the present disclosure is configured to seal a gap between a first member that has a sectionally curved groove and a second member. The gasket includes a rubber-like elastic base and at least two pairs of rubber-like elastic fins. The base can be inserted into the groove, and has a height allowing the base to be compressed when the first member and the second member are coupled to each other. The at least two pairs of fins protrude at different heights from the both side surfaces of the base, and can elastically deform in a direction opposite to an insertion direction when the base is inserted into the groove so that the fins contact the side walls of the groove. The base and the fins are integrally formed with each other as one unitary member by extrusion.

### Advantageous Effects

A gasket according to the present disclosure can be formed by extrusion and easily attached into a groove which can be easily formed by presswork.

### BRIEF DESCRIPTION OF DRAWINGS

FIG. 1 is a schematic view of an electric car illustrating a storage part for a battery.

FIG. 2A is a schematic view of a battery case illustrating a part sealed by a gasket outlined with a single-dot-dashed line.

FIG. 2B is a cross-sectional view taken along the line A-A line in FIG. 2A.

FIG. 3A is a vertical cross-sectional view showing an exemplary groove.

FIG. 3B is a vertical cross-sectional view showing another exemplary groove which has a depth smaller than the groove shown in FIG. 3A.

FIG. 3C is a vertical cross-sectional view showing still another exemplary groove which has a depth greater than the groove shown in FIG. 3A.

FIG. 4 is a plan view showing a gasket according to a first embodiment.

FIG. 5 is a cross-sectional view taken along the line A-A in FIG. 4.

FIG. 6 is a vertical cross-sectional view showing the gasket superimposed in a groove.

FIG. 7 is a perspective view showing the gasket arranged in the groove.

FIG. 8 is an enlarged plan view of the area B in FIG. 4 including a connection place of the gasket.

FIG. 9A is a vertical cross-sectional view showing the gasket before attachment.

FIG. 9B is a vertical cross-sectional view showing the gasket under attachment operation.

FIG. 9C is a vertical cross-sectional view showing the gasket after attachment.

FIG. 10 is a plan view showing a gasket according to a second embodiment.

FIG. 11A is a vertical cross-sectional view showing the gasket before attachment.

FIG. 11B is a vertical cross-sectional view showing the gasket under attachment operation.

### DETAILED DESCRIPTION

The following description will describe gaskets according to embodiments with reference to drawings. The gaskets according to the embodiments seal a battery case of a battery which is installed in an electric car.

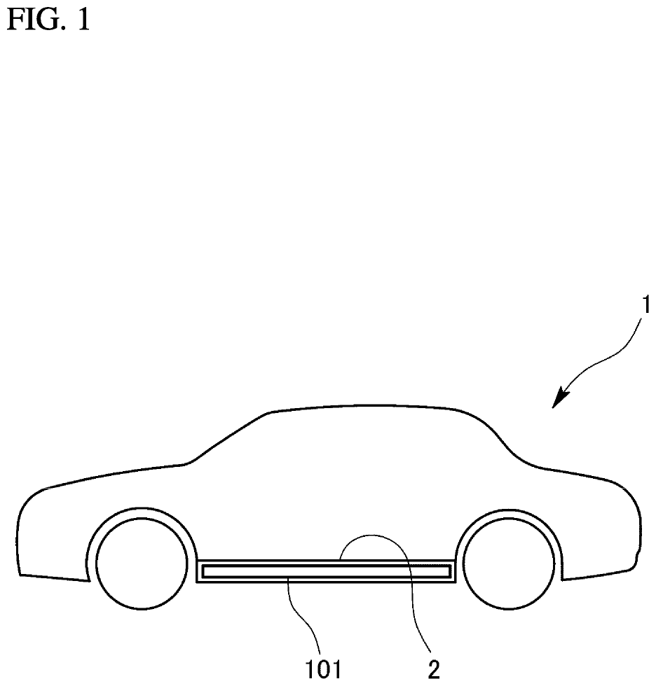

An electric car 1 includes a flat, thin and large battery 101 as shown in FIG. 1. The battery 101 is accommodated under a floor 2 of the electric car 1.

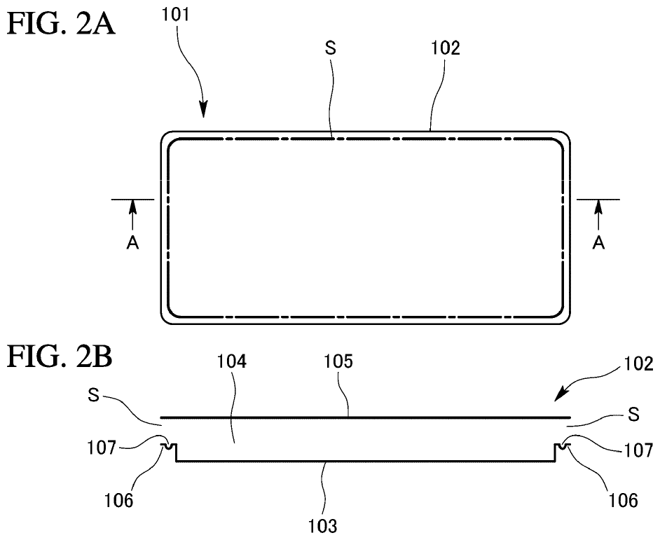

The battery 101 includes various types of elements (not shown) inside the battery case 102 shown in FIGS. 2A and 2B. The battery case 102 includes a flat and thin box-shaped case 103 which has a rectangular shape in a plan view and opens on its upper surface side for example. The case 103 has an opening 104 which is closed by a cover 105.

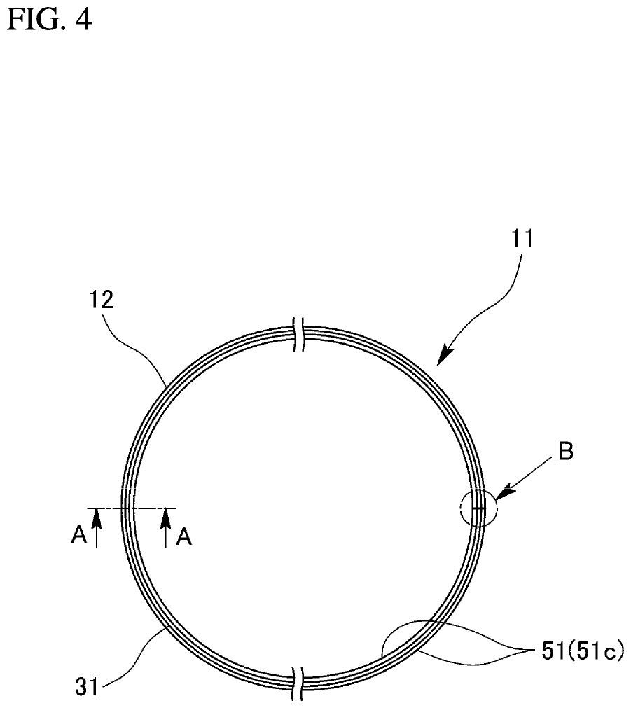

A sealing part S shown in FIG. 2A by a single-dot-dashed line corresponds to a coupling part of the case 103 and the cover 105. A gasket 11 (shown in FIGS. 4 to 11B) is arranged in the sealing part S. The gasket 11 seals a gap between the case (first member) 103 and the cover (second member) 105.

The sealing part S extends along the coupling part between a flange 106, which is bent outward from the edges of the case 103, and the cover 105 as shown in FIG. 2B. A groove 107 is entirely formed along the flange 106. The gasket 11 is inserted into the groove 107.

Because the sealing part S is located on the interior side relative to the outer periphery of the battery case 102, the peripheral length of sealing part S is correspondingly shorter than the peripheral length of the outer periphery of the battery 101 which is defined by the battery case 102. The peripheral length of the battery 101 is likely to increase with the body size of the electric car 1, and generally falls within a range from about 3000 to 6000 mm.

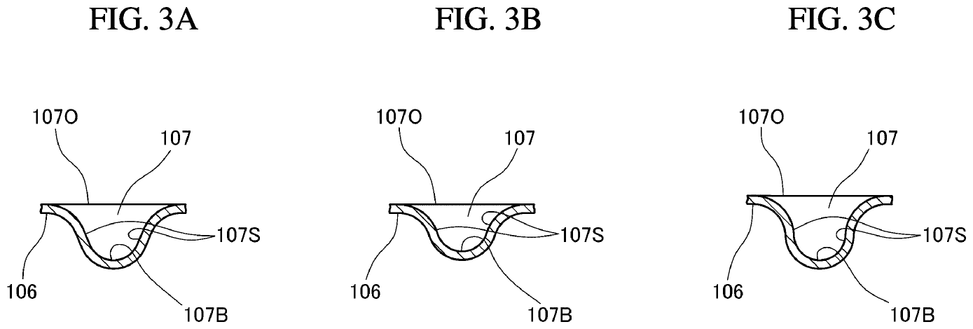

FIGS. 3A, 3B and 3C are vertical cross-sectional views showing various types of grooves 107 which are formed in their flange 106. The groove 107 shown in FIG. 3B is shallower than the groove 107 shown in FIG. 3A. The groove 107 shown in FIG. 3C is deeper than the groove 107 shown in FIG. 3A. The grooves 107 shown in FIGS. 3A to 3C have a shape which can be formed by only one presswork step in presswork when the case 103 is manufactured. The grooves 107 have such manufacturing constraints on their structure. Accordingly, the grooves 107 have a curved shape as viewed in a section. For this reason, the grooves 107 have a bottom 107B having a certain curvature.

The grooves 107 shown in FIGS. 3A, 3B and 3C are merely illustrative. Various changes can be made in practical applications. For example, various changes can be made to the size and depth of an opening 1070, the curvature of side walls 107S, the curvature of the bottom 107B, and the like as long as the groove can be formed by only one presswork step.

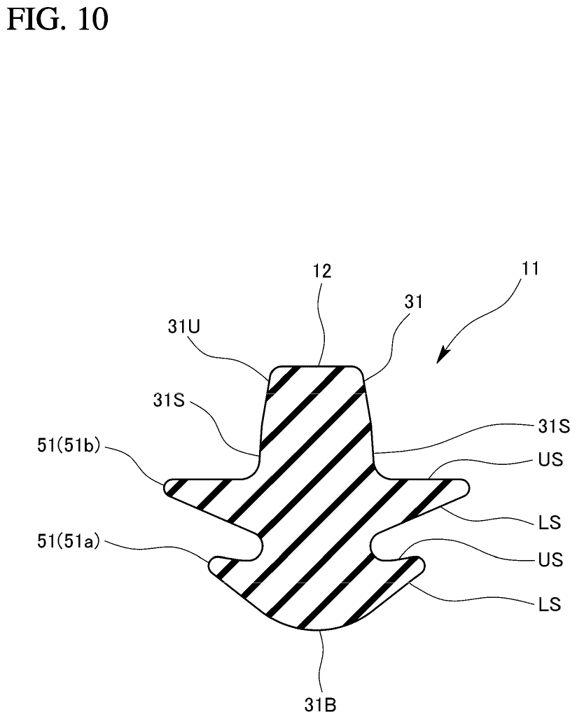

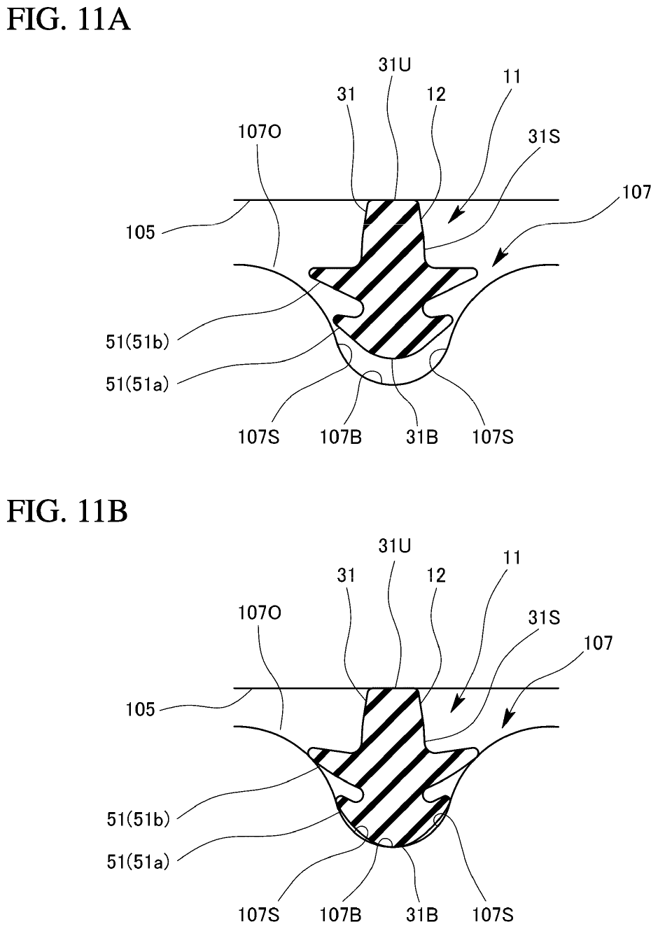

The following description will describe a gasket 11 according to a first embodiment shown in FIGS. 4 to 9C, and a gasket 11 according to a second embodiment shown in FIGS. 10, 11A and 11B.

### First Embodiment

The gasket 11 according to this embodiment has a constant shape along its peripheral direction as shown in FIG. 4. The gasket 11 shown in FIG. 4 has a circular or oval shape. However, such a shape is merely illustrative as examples of the gasket 11. The gasket 11 is formed of only rubber. For example, the gasket 11 can have various shapes before inserted into and held in the groove 107, which is formed along the flange 106, or the like.

The gasket 11 according to this embodiment is a rubber-like elastic body 12 which is formed by extrusion. The rubber-like elastic body 12 has a rubber hardness degree not lower than 70, for example. The gasket 11 has not a simple shape such as O ring but a plurality of fins 51 which extend from a base 31, for example. The base 31 and the fins 51 are integrally formed with each other as one unitary member by one extrusion step without additional processing. The base 31 is a part of the rubber-like elastic body 12. Also, the fins 51 are other parts of the rubber-like elastic body 12.

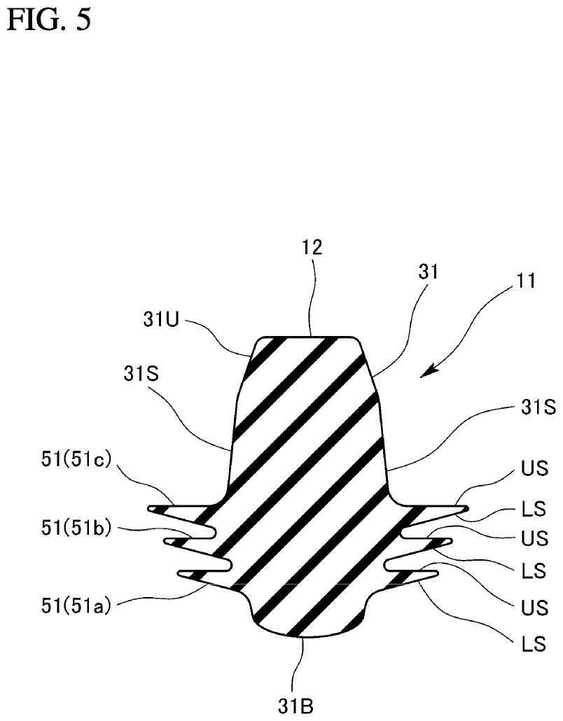

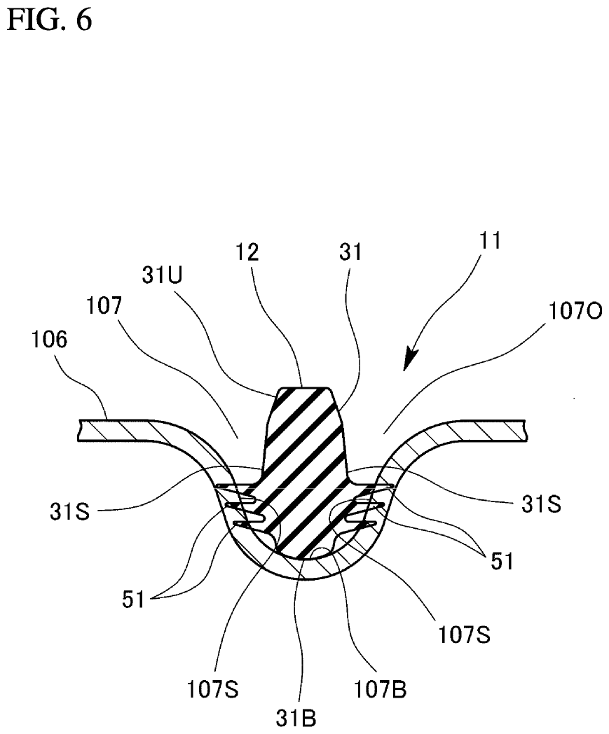

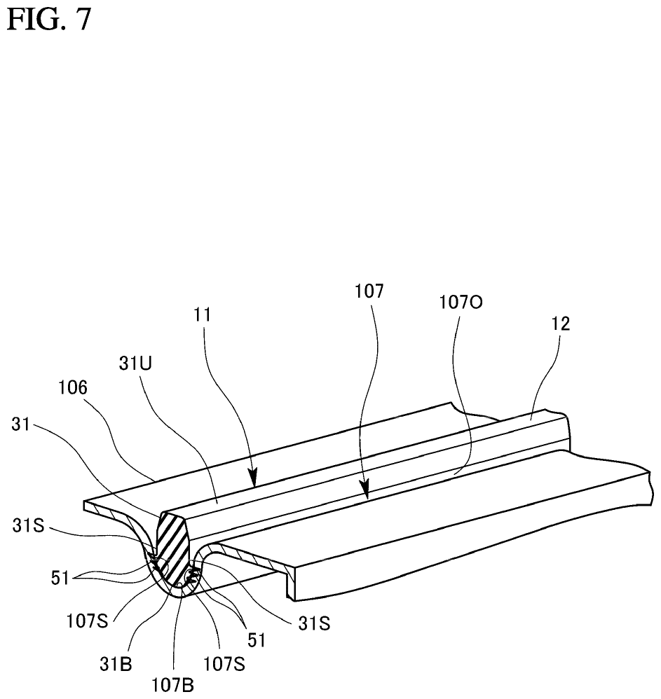

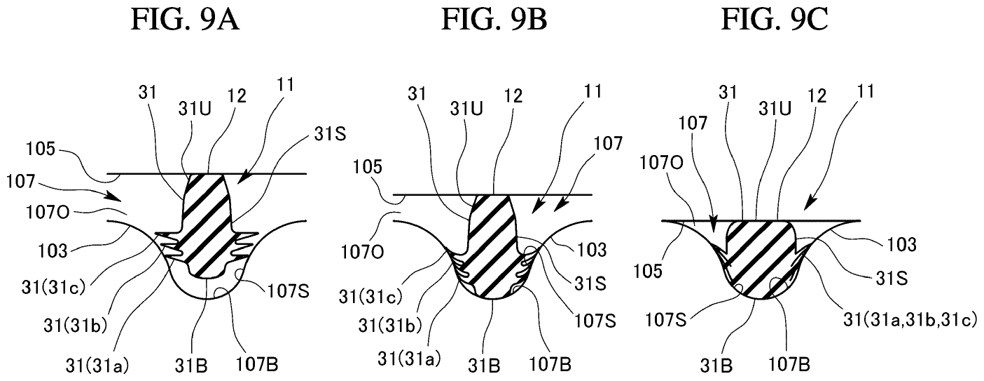

The vertical cross-sectional shape of the gasket 11 which includes the base 31 and the fins 51 can be clearly seen from FIG. 5 as cross-sectional view taken along the line A-A in FIG. 4. The static relationship between the groove 107 and the gasket 11 can be clearly seen from FIG. 6 (vertical cross-sectional view) and FIG. 7 (perspective view) showing the gasket 11 superimposed/arranged in the groove 107, which is formed along the flange 106. In addition, the dynamic relationship between the groove 107 and the gasket 11 can be clearly seen from FIGS. 9A, 9B, and 9C showing the shape change of the gasket 11 in in the groove 107 in attachment when the cover 105 is coupled to the case 103.

The base 31 has a rectangular shape which has a vertical length longer than its horizontal length as viewed in a section. More specifically, the base 31 has not a precisely rectangular shape but a barrel shape which bulges in a central height part of side walls 31S relative to its bottom part 31B and upper part 31U.

The bottom part 31B has a sectionally curved shape having a curvature. The curvature of the bottom part 31B of the base 31 is greater than the curvature of the bottom 107B of the groove 107. Accordingly, when the gasket 11 is placed in the groove 107, the groove 107 can provide enough space to accommodate the base 31 (see FIGS. 6, 7, and 9B). After that, when the gasket 11 seals a gap between the two members (i.e., flange 106 and cover 105), the base 31 tightly contacts the bottom 107B of the groove 107 without gap (see FIG. 9C).

The upper part 31U of the base 31 has a tapered shape from a midpoint between the central height part and the top. The tapered degree becomes higher toward the top.

The base 31 has a height which allows the base to be compressed when the cover 105 is coupled to the flange 106 (see FIGS. 9A and 9B and 9C). In the words, the height of the base 31 is greater than the depth of the groove 107. Also, the base 31 elastically deforms and seals a gap between the flange 106 and the cover 105 when the cover 105 is coupled to the flange 106.

Three pairs of fins 51 protrude at different heights from the both side surfaces 31S of the base 31. In other words, three (top, middle, and bottom) fins 51 are arranged on their corresponding side surface (each of the right and left side surfaces) of the base 31. These three (bottom, middle, and top) fins are attached with reference signs 51a, 51b, and 51c in this order from the bottom fin, which is closest to the bottom part 31B of the base 31, to the top fin for ease of explanation.

The protruding amount of the fins 51 (51a, 51b, 51c) increases with their height. According to this arrangement and the barrel shaped base 31, a hypothetical surface which is obtained by connecting ends of the fins 51 (51a, 51b, 51c) spreads upward.

The fins 51 have a shape which becomes thinner toward their end. The fins 51 have an upper surface US which extends parallel to a hypothetical plane perpendicular to the center axis of the base 31. That is, the inclination angle of the upper surface US with respect to the hypothetical plane is zero degree. The fins 51 have a lower surface LS. The lower surface has an inclination angle of roughly 15 degrees, for example, from about 10 to 20 degrees with respect to the hypothetical plane. Accordingly, the inclination angle of the lower surface LS of the fin 51 with respect to the hypothetical plane is greater than the upper surface US.

The fins 51 have a length which allows the fins to elastically deform in a direction opposite to an insertion direction, when the base 31 is inserted into the groove 107 and the fins contact the side walls 31S of the groove 107 (see FIGS. 6, 7, and 9B). Also, three (top, middle, and bottom) fins 51 which are arranged on each of the side walls 31S of the base 31 deform along the side wall 107S and tightly contact each other without gap between them when the cover 105 is coupled to the flange 106. Such a shape, length, arrangement interval, elasticity, and the like which provide the tight contact are provided to the fins 51.

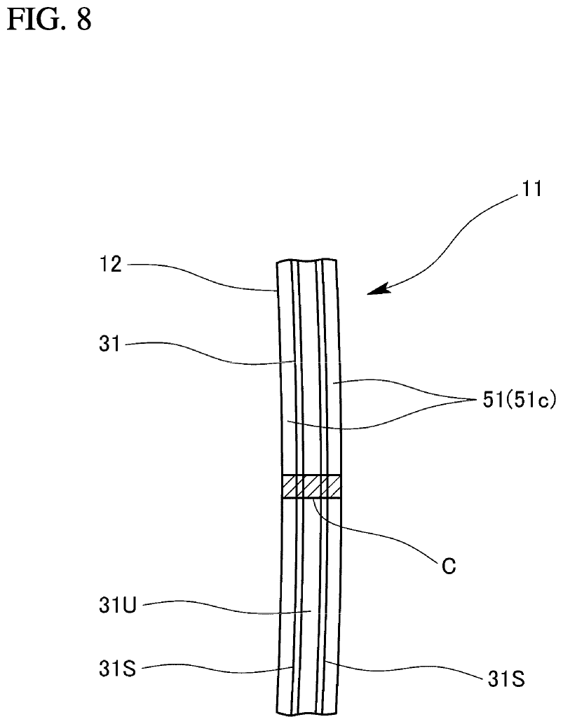

FIG. 8 is an enlarged plan view of the area B in FIG. 4 including a connection place (connection part) of the gasket 11. The gasket 11 has a constant shape along its peripheral direction as shown in FIG. 4. That is, the shape shown in FIG. 5 can be seen at any peripheral position as viewed in a section. The reason is that the gasket 11 is integrally formed by one extrusion step without additional processing. The both ends of a length of the gasket 11 which is formed by extrusion are connected to each other at the connection place C of the gasket 11 by forming the connection part.

When the cover 105 is coupled to the flange 106 so that the battery case 102 is closed, sealing of a gap between the flange 106 and the cover 105 can be achieved by accommodating the gasket 11 into the groove 107. The attachment operation is now described with reference to FIGS. 9A, 9B, and 9C.

The gasket 11 is inserted into the groove 107 as shown in FIG. 9A. The insertion workability is good, because the bottom 107B of the groove 107 which has a width smaller than the groove 107 and a curvature greater than the bottom part 31B of the base 31 is inserted into the groove 107 which is formed in a sectionally curved shape and has the wide opening 1070. In the insertion, when the gasket 11 is inserted into the groove 107, the fins 51 contact the side walls 107S of the groove 107 and elastically deform so that the elastic deformation gives resistance. However, the workability of insertion of the gasket 11 is not reduced. That is because the fins 51 have a small thickness in the vertical direction, and easily elastically deform. For this reason, the gasket 11 can be easily inserted into the groove 107.

When the gasket 11 is inserted into curved parts of the groove 107 which are located in the corners of the case 103, the good workability of insertion the gasket 11 into the groove 107 will become remarkable. The reason is that, according to the shape of the groove 107 and the characteristics of the fins 51, the gasket 11 is not too tight in the groove 107 when inserted into the groove. The gasket 11 can be easily inserted even into the curved parts of the groove 107, which are located in the corners, without correcting its shape.

When the gasket 11 is accommodated in the groove 107, the bottom part 31B of the base 31 is placed on the bottom 107B of the groove 107, and the fins 51 are pressed against the side walls 107S of the groove 107 as shown in FIG. 9B. Insertion operation of the base 31 into the groove 107 brings the fins 51 into contact with the side walls 107S of the groove 107 so that the fins elastically deform in a direction opposite to the insertion direction. The recovery of the deformed fins 51 applies press force onto the side walls 107S of the groove 107, and prevents the gasket 11 from dropping off from the groove 107. As a result, the gasket 11 can be stably held in the groove 107 without moving upward from the bottom 107B of the groove 107.

Also, the dropping possibility of the gasket 11 from the groove 107 can be reduced by the curvature difference between the bottom part 31B of the base 31 and the bottom 107B of the groove 107. Although the good insertion workability of the gasket 11 can be provided by the shape of the groove 107 which spreads from the bottom 107B toward the opening 107O, the accommodated gasket 11 will be likely to drop off. If the bottom part 31B of the base 31 has a curvature smaller than the bottom 107B of the groove 107, the bottom part 31B of the base 31 will be fitted in the bottom 107B of the groove 107 and caught in the groove 107 by its elastic deformation. In this condition, the gasket 11 will easily drop off from the groove 107 when a shock triggers disengagement from the fitted engagement. Contrary to this, because the bottom part 31B of the base 31 according to this embodiment has a curvature greater than the bottom 107B of the groove 107, the bottom part 31B is not caught in the groove 107 by its elastic deformation. For this reason, the dropping possibility of the gasket 11 from the groove 107 can be reduced.

After the gasket 11 is accommodated in the groove 107, the base 31 is compressed when the battery case 102 is closed by coupling the cover 105 to the flange 106 as shown in FIG. 9C. The compressed base 31 elastically deforms not only in the vertical direction but also in the horizontal direction. The base 31 which elastically deforms in the horizontal direction have two effects. One effect is to bring the bottom part 31B of the base 31 into tight contact with the bottom 107B of the groove 107 without gap. Another effect is to bring the three pairs of fins Ma, 51b, and 51c which are arranged on the right and left sides into tight contact with each other without gap.

However the tight contact of the three pairs of fins 51a, 51b, and 51c, which are arranged on the right and left sides of the base 31, with each other without the gap is provided not only by the effect of the compressed base 31. As discussed above, the tight contact also depends on the shape, length, arrangement interval, elasticity, and the like of the fins 51. The tight contact of the fins 51a, 51b, and 51c with each other without the gap is promoted by any of the shape of the fins 51 which becomes thinner toward their end and the shape of the fins 51 which has an inclination angle of the lower surface LS of the fin 51 with respect to the hypothetical plane perpendicular to the center axis of the base 31 greater than the upper surface US.

As a result, good sealing performance of the gasket 11 is provided by the tight contact of the bottom part 31B of the base 31 with the bottom 107B of the groove 107 without gap, and the tight contact of the three pairs of fins 51a, 51b, and 51c, which are arranged on the right and left sides of the base 31, with each other without the gap.

According to the gasket 11 of this embodiment, good attachment workability and good sealing performance are ensured.

Also, because the gasket 11 according to this embodiment is a rubber-only type gasket which can be formed by extrusion, it can be easily manufactured.

In addition, the gasket 11 according to this embodiment does not require laborious processing on the flange 106 as contact member on the battery case 102 side to be contacted by the gasket. Because only one presswork step is required to form the groove 107 on the flange 106, the entire manufacturing process and facilities can be simple and be easily provided.

### Second Embodiment

A gasket 11 according to a second embodiment is described with reference to FIGS. 10, 11A, and 11B. Parts same as those of the first embodiment are attached with the same reference signs, and their description is omitted.

The number and shape of the fins 51 of the gasket 11 according to this embodiment are different from the first embodiment. Two pairs of fins 51 protrude at different heights from the both side surfaces 31S of the base 31. In other words, two (top and bottom) fins 51 are arranged on their corresponding side surface (each of the right and left side surfaces) of the base 31. One of the fins 51 which is located on the bottom side is referred to as fin 51a, and another fin 51 which is located on the top side is referred to as fin 51b, for ease of explanation.

The protruding amount of the fin 51b is greater than the protruding amount of the fin 51a. According to this arrangement and the barrel shaped base 31, a hypothetical surface which is obtained by connecting ends of the fins 51a and 51b spreads upward. This feature is similar to the first embodiment.

The fins 51 have a shape which becomes thinner toward their end. This feature is also similar to the first embodiment. Here, the fins 51 according to this embodiment are thicker than the first embodiment as a whole. The fins are now described in more detail.

The fin 51a, which is located on the bottom side, has an upper surface US having an inclination angle of about 5 degrees with respect to the hypothetical plane perpendicular to the center axis of the base 31. The fins 51a have a lower surface LS. The lower surface has an inclination angle of roughly 35 degrees, for example, from about 30 to 40 degrees with respect to the hypothetical plane. The fins 51 according to the first embodiment have been described to have the upper surface US having an inclination angle of zero degree and the lower surface LS having an inclination angle of roughly 15 degrees with respect to the hypothetical plane. That is, the difference between the inclination angles of the upper surface US and the lower surface LS in the second embodiment is about 15 degrees greater than the difference between the inclination angles of the upper surface US and the lower surface LS in the first embodiment. As a result, the fins 51a, which are located on the bottom side, have a thickness greater than the fins 51 according to the first embodiment.

The fins 51b, which are located on the top side, have an upper surface US which extend parallel to the hypothetical plane. That is, the inclination angle of the upper surface US with respect to the hypothetical plane is zero degree. The fins 51b have a lower surface LS. The lower surface has an inclination angle of roughly 25 degrees, for example, from about 20 to 30 degrees with respect to the hypothetical plane. The fins 51 according to the first embodiment have been described to have the lower surface LS having an inclination angle of roughly 15 degrees with respect to the hypothetical plane. That is, the difference between the inclination angles of the upper surface US and the lower surface LS of the fins 51b in the second embodiment is about 10 degrees greater than the difference between the inclination angles of the upper surface US and the lower surface LS in the first embodiment. As a result, the fins 51b, which are located on the top side, have a thickness greater than the fins 51 according to the first embodiment.

A significant difference of the gasket 11 according to this embodiment from the gasket 11 according to the first embodiment is that the fins 51a, which are located on the bottom side, are not separately arranged from the bottom part 31B of the base 31 but form one part together with the bottom part 31B of the base 31. The curved surface of the bottom part 31B of the base 31 continuously extends from the lower surfaces LS of the fins 51a, which are located on the bottom side, as viewed in a vertical cross-sectional view so that they form a single convex shape.

When the cover 105 is coupled to the flange 106 so that the battery case 102 is closed, sealing of a gap between the flange 106 and the cover 105 can be achieved by accommodating the gasket 11 into the groove 107. The attachment is now described with reference to FIGS. 11A and 11B.

The gasket 11 is inserted into the groove 107 as shown in FIG. 11A. The insertion workability is good, because the base 31 which is substantially narrower than the groove 107 is inserted into the groove 107 which is formed in a sectionally curved shape and has the wide opening 107O. The reason to express the base 31 as “substantially narrower” is that its fins 51 have a small thickness in the vertical direction and can easily elastically deform so that the fins do not give large resistance as compared with the base 31 when the gasket 11 is inserted into the groove 107. Although the fins 51 according to this embodiment are thicker than the fins 51 according to the first embodiment and correspondingly have higher rigidity than the fins 51 according to the first embodiment, the number of the fins 51 according to this embodiment is two on each side (each of the right and left sides) which is smaller than the first embodiment. For this reason, the fins 51 do not give large resistance as compared with the base 31 when the gasket 11 is inserted into the groove 107 similarly to the first embodiment. As a result, the workability of insertion of the gasket 11 into the groove 107 is not reduced.

The gasket 11 according to this embodiment can be also easily inserted even into the curved parts of the groove 107, which are located in the corners of the case 103, without correcting its shape when the gasket 11 is inserted into the curved parts.

When the gasket 11 is accommodated in the groove 107, the bottom part 31B of the base 31 which continuously extends from the fins 51a located on the bottom side is placed on the bottom 107B of the groove 107, and the bottom fins 51a and the top fins 51b are pressed against the side walls 107S of the groove 107 as shown in FIG. 11B. The dropping possibility of the gasket 11 from the groove 107 can be reduced by the recovery of the fins 51a and 51b.

The base 31 is compressed when the battery case 102 is closed by coupling the cover 105 to the flange 106. The compressed base 31 elastically deforms not only in the vertical direction but also in the horizontal direction. The compression brings the bottom part 31B of the base 31 in tight contact with the bottom 107B of the groove 107 without gap, and the two fins 51a and 51b, which are arranged on each side (each of the right and left sides), in tight contact with each other without gap. As a result, the gasket 11 can have good sealing performance

### Modified Embodiment

Various changes and modifications can be made in practical applications.

For example, the number of the fins 51 and the shapes of fins 51 which have been described in the first and second embodiments are merely illustrative as examples, and various changes can be made to the number or shapes. The number of the fins 51 which are required to protrude at different heights on each of the side walls 31S of the base 31 is at least two. For example, four or more of fins may be arranged on each side. The upper surface US and lower surface LS of the fins 51 may have inclination angles different from the first and second embodiments.

Any other changes and modifications can be made in practical applications.

### REFERENCE SIGNS LIST

1 . . . Electric Car
2 . . . Floor
11 . . . Gasket
12 . . . Rubber-Like Elastic Body
31 . . . Base
31B . . . Base Bottom Part
31S . . . Base Side Wall
31U . . . Base Upper Part
51 . . . Fin
51a . . . Fin
51b . . . Fin
51c . . . Fin
101 . . . Battery
102 . . . Battery Case
103 . . . Case (First Member)
104 . . . Opening
105 . . . Cover (Second Member)
106 . . . Flange
107 . . . Groove
107B . . . Groove Bottom
107O . . . Groove Opening
107S . . . Groove Side Wall
C . . . Connection Part
S . . . Sealing Part
LS . . . Lower Surface
US . . . Upper Surface

1. A gasket configured to seal a gap between a first member that as a sectionally curved groove and a second member, the gasket comprising:
a rubber-like elastic base configured to be inserted into the groove, the base having a height allowing the base to be compressed when the first member and the second member are coupled to each other; and
at least two pairs of rubber-like elastic fins protruding at different heights from both side surfaces of the base, the fins configured to elastically deform in a direction opposite to an insertion direction when the base is inserted into the groove so that the fins contact the side walls of the groove,
wherein the base and the fins are integrally formed with each other as one unitary member by extrusion.

2. The gasket according to claim 1, wherein the base has a height greater than a depth of the groove.

3. The gasket according to claim 1, wherein the tins adjacent to each other are configured to tightly contact each other without gap between them when the first member and the second member are coupled to each other.

4. The gasket according to claim 1, wherein the fins become thinner toward their end.

5. The gasket according to claim 1, wherein the fins have upper and lower surfaces, and an inclination angle of the lower surface with respect to a hypothetical plane perpendicular to a center axis of the base is greater than an inclination angle of the upper surface with respect to the hypothetical plane.

6. The gasket according to claim 1, wherein the base has a bottom part configured to tightly contact a bottom of the groove without gap when the first member and the second member are coupled to each other.

7. The gasket according to claim 6, wherein the bottom part of the base has a sectionally curved shape having a curvature greater than the bottom of the groove.

8. The gasket according to claim 1, further comprising:
a connection part connecting e both ends of the base and the fins, which are formed by extrusion, to each other.

9. The gasket according to claim 2, wherein the fins adjacent to each other are configured to tightly contact each other without gap between them when the first member and the second member are coupled to each other.

10. The gasket according to claim 2, wherein the fins become thinner toward their end.

11. The gasket according to claim 3, wherein the fins become thinner toward their end.

12. The gasket according to claim 2, wherein the fins have upper and lower surfaces, and an inclination angle of the lower surface with respect to a hypothetical plane perpendicular to a center axis of the base is greater than an inclination angle of the upper surface with respect to the hypothetical plane.

13. The gasket according to claim 3, wherein the fins have upper and lower surfaces, and an inclination angle of the lower surface with respect to a hypothetical plane perpendicular to a center axis of the base is greater than an inclination angle of the upper surface with respect to the hypothetical plane.

14. The gasket according to claim 4, wherein the fins have upper and lower surfaces, and an inclination angle of the lower surface with respect to a hypothetical plane perpendicular to a center axis of the base is greater than an inclination angle of the upper surface with respect to the hypothetical plane.

15. The gasket according to claim 2, wherein the base has a bottom part configured to tightly contact a bottom of the groove without gap when the first member and the second member are coupled to each other.

16. The gasket according to claim 3, wherein the base has a bottom part configured to tightly contact a bottom of the groove without gap when the first member and the second member are coupled to each other.

17. The gasket according to claim 4, wherein the base has a bottom part configured to tightly contact a bottom of the groove without gap when the first member and the second member are coupled to each other.

18. The gasket according to claim 5, wherein the base has a bottom part configured to tightly contact a bottom of the groove without gap when the first member and the second member are coupled to each other.

19. The gasket according to claim 2, further comprising:
a connection part connecting the both ends of the base and the fins, which are formed by extrusion, to each other.

20. The gasket according to claim 3, further comprising:
a connection part connecting the both ends of the base and the fins, which are formed by extrusion, to each other.
